(19) United States
(12) Patent Application Publication
(10) Pub. No.: US 2017/0166322 A1
(43) Pub. Date: Jun. 15, 2017

(54) INFRARED TEMPERATURE MONITORING SYSTEM FOR AIRCRAFT

(71) Applicant: Dexter Research Center, Inc., Dexter, MI (US)

(72) Inventors: Charles Edward SCHNEIDER, Garden City, MI (US); Jeffrey Allan ZEWICKE, Commerce Township, MI (US)

(21) Appl. No.: 15/379,843

(22) Filed: Dec. 15, 2016

Related U.S. Application Data
(60) Provisional application No. 62/267,361, filed on Dec. 15, 2015.

(51) Int. Cl. B64D 45/00; G01J 5/02; G01J 5/10

(52) U.S. Cl. CPC B64D 45/00; G01J 5/10; G01J 5/025; B64D 2045/0085

(57) ABSTRACT

An infrared temperature monitoring system for measuring the temperature of areas or subsystems of an aircraft is provided. The system includes a plurality of infrared sensors each configured for non-contact measurement of temperature associated with the areas or subsystems of the aircraft. Each of the plurality of infrared sensors has a unique node address and outputs an associated sensor signal. A temperature processing unit receives the sensor signal from each of the plurality of infrared sensors and analyzes the sensor signals based at least in part on the unique node address and outputting an interface signal. An interface system receives the interface signal from the temperature processing unit and outputs a control signal.

### CROSS-REFERENCE TO RELATED APPLICATIONS

This application claims the benefit of U.S. Provisional Application No. 62/267,361, filed on Dec. 15, 2015. The entire disclosure of the above application is incorporated herein by reference.

### FIELD

The present disclosure relates to infrared temperature monitoring systems for aircraft.

### BACKGROUND AND SUMMARY

This section provides background information related to the present disclosure which is not necessarily prior art. This section provides a general summary of the disclosure, and is not a comprehensive disclosure of its full scope or all of its features.

According to some embodiments of the present teachings, a temperature monitoring system is provided that employs smart infrared (IR) sensor units to measure the temperature of areas of an aircraft or any of its subsystems within the field of view of individual detection units. These Smart IR Sensors have their own local decision making capabilities on monitored status, thus offloading valuable processing time from the host computer. The system can be customized to provide data for any aircraft device, such as anti-icing devices, bleed air systems, hydraulic fluids systems, fuel systems, braking systems, wheels systems, and other systems, including their control units.

Compared to prior art systems, the present teachings use radiated energy (e.g. non-contact) rather than conductive energy (e.g. contact) for temperature conversion. Prior art temperature monitoring systems use contact sensors to measure the temperature at specific locations within the areas or subsystems of interest. Prior temperature monitoring systems, such as thermocouple or conductive salt-wire tube based units, are not capable of measuring the temperature of areas within customizable field of views with the fast response time (500 milliseconds) of the present teachings. This allows for a greater/faster decision time span in critical situations that could develop on an aircraft.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an infrared temperature monitoring system according to some embodiments of the present teachings for an aircraft;

FIG. 2 is a functional block diagram of each element of the infrared temperature monitoring system according to some embodiments of the present teachings;

FIG. 3 is a functional block diagram of the smart infrared temperature sensor according to some embodiments of the present teachings;

FIG. 4 is a flowchart of a main process loop of the smart infrared temperature sensor according to some embodiments of the present teachings;

FIG. 5 is a flowchart of an interrupt service routine of the smart infrared temperature sensor according to some embodiments of the present teachings;

FIG. 6 is a flowchart of a read temperature and decision routine of the smart infrared temperature sensor according to some embodiments of the present teachings;

FIG. 7 is a flowchart of a communication decision routine of the smart infrared temperature sensor according to some embodiments of the present teachings; and

FIG. 8 is a flowchart of the temperature processing unit (TPU) host processor display temperature and decision routine according to some embodiments of the present teachings.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to the principles of the present teachings, an infrared temperature monitoring system for measuring the temperature of areas or subsystems of an aircraft is provided having advantageous constructions and method of using the same. The system can include a plurality of infrared sensors each configured for non-contact measurement of temperature associated with the areas or subsystems of the aircraft. Each of the plurality of infrared sensors can include a unique node address and output an associated sensor signal. A temperature processing unit can receive the sensor signal from each of the plurality of infrared sensors and analyzes the sensor signals based at least in part on the unique node address and outputs an interface signal. An interface system receives the interface signal from the temperature processing unit and outputs a control signal.

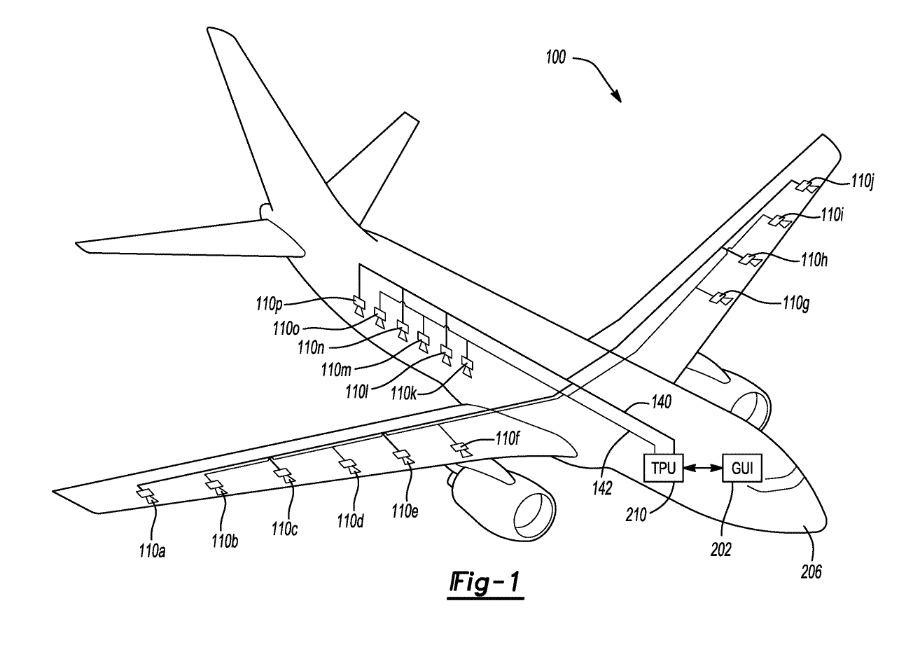

FIG. 1 is a schematic illustration of an infrared temperature monitoring system 100 for an aircraft 206 according to some embodiments of the present teachings. Referring to FIG. 1, in this embodiments, aircraft 206 may include a plurality of smart infrared (IR) sensors 110a-110p (generally denoted as “110”) to monitor temperatures (e.g. outer surface tempatures) of the aircraft. It should be understood that any number of sensors may be used in connection with the present teachings. These sensors may be placed in areas of interest for use with anti-icing devices, bleed air systems, hydraulic fluids systems, fuel systems, braking systems, wheels systems, and other systems, including their control units. In some embodiments, the system 100 provides for two separate communication buses 140, 142 from the host Temperature Processing Unit (TPU) 210. Smart IR Sensors 110 can be grouped in pairs, with one on each communication bus 140, 142, to provide system redundancy in case of network failure. The TPU 210 and/or Graphical User Interface system (GUI) 202 may be placed in a location viewable by the aircraft crew members to permit monitoring of the system alarms and warnings.

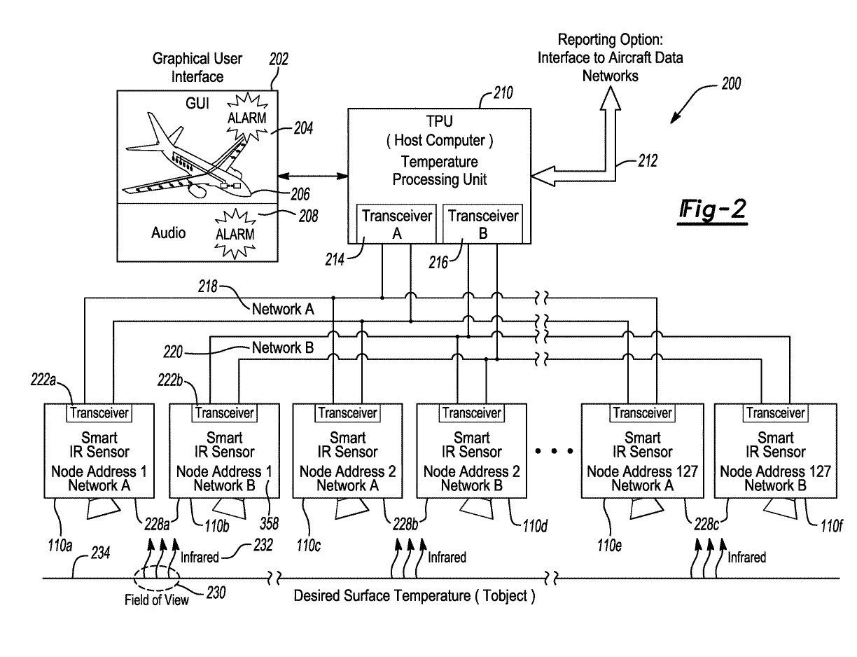

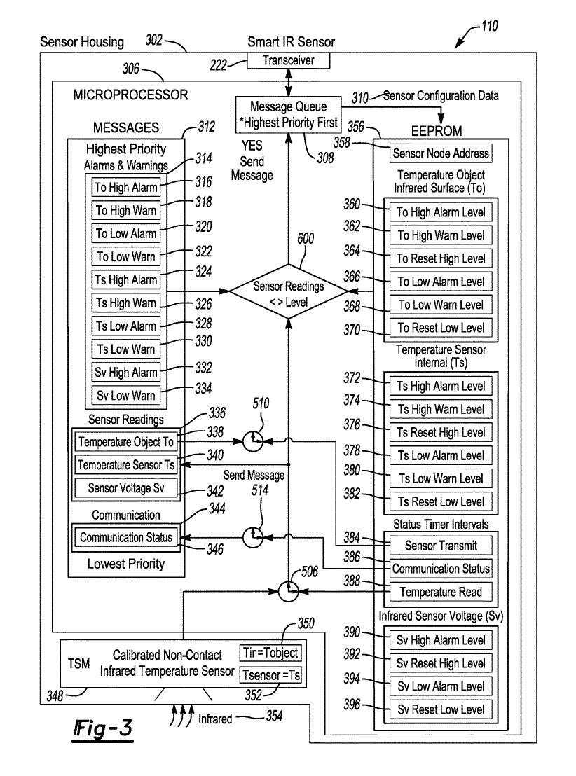

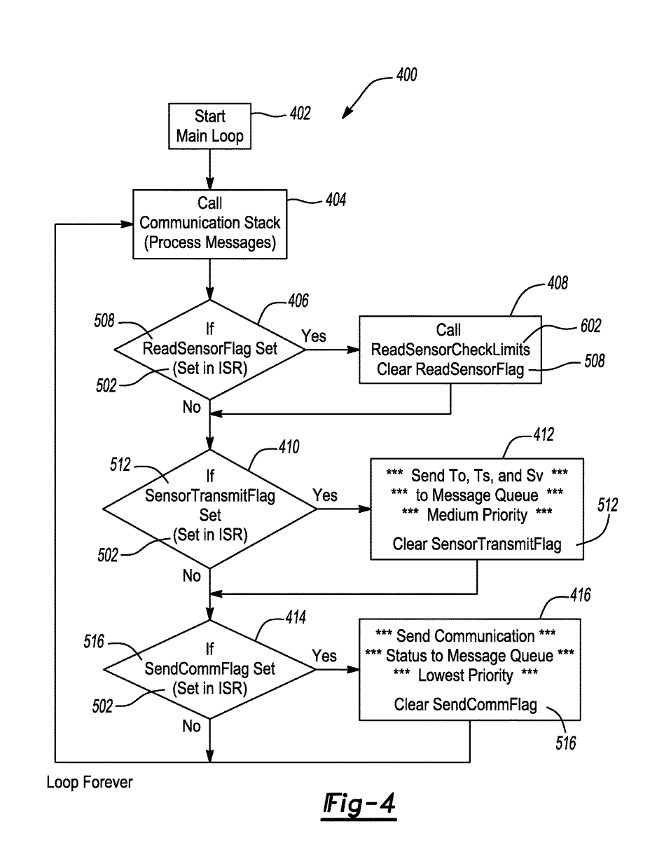

FIG. 2 is a functional block diagram of each element of infrared temperature monitoring system 100 according to some embodiments of the present teachings. Referring to FIG. 2, the Graphical User Interface (GUI) 202 provides both visual and audio feedback to the aircraft crew members. In some embodiments, GUI 202 can also provide a means for sensor configuration data 310 (FIG. 3), thus allowing each sensor to be tailored to a vast variety of aircraft system and/or configuration parameters. In some embodiments, GUI 202 has at least, but not limited to, three main features: visual indication of an alarm/warning condition 204, audio indication of an alarm/warning condition 208, and visual position indication of alarm/warning condition 206. In some embodiments, other combinations and operations can be envisioned.

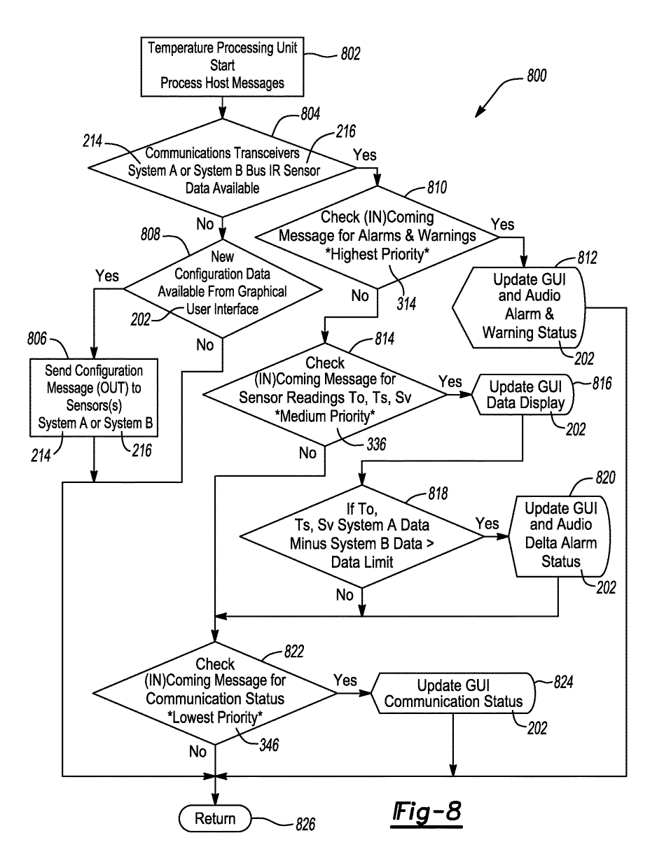

Updating GUI 202 is the responsibility of the Temperature Processing Unit (TPU) 210. Many aircraft, in particular commercial airlines, require system redundancy in-case of system failure. In some embodiments, TPU 210 has two, but not limited to, transceivers—Transceivers A 214 and Transceivers B 216 for communication with each Smart IR Sensor 110 via its own Transceivers 222 (e.g. 222a and 222b) incorporated into each Smart IR Sensor 110. Network A 218 and Network B 220 may be, but not limited to, any of the now or future approved communication protocols for networks in aircraft. Upon receiving messages from each Smart IR Sensor 110, TPU 210 will assess (800; FIG. 8) each message based on its Node Address 358 (that is, the Node Address of the corresponding Smart IR Sensor) to determine how it should update each of the GUI's entities 204, 206, 208. By the use of Node Addresses, a physical location may be visualized on the GUI screen 206.

For redundancy, in some embodiments, two or more Smart IR Sensors 110 (e.g. 110a and 110b, 110c and 110d, and 110e and 110f) can be focused on or otherwise configured to monitor the same Desired Surface Temperature (T_{object}) section to form a sensor pair 228a, 228b, 228c (generally denoted as 228). The amount of infrared radiation 232 will be viewed 230 by each sensor equally, thus reporting the same Temperature.

In some aircraft installations, it may be required to report any alarms/warnings to other aircraft data networks 212. As an example, consider a system designed for anti-icing of the wing surfaces, wherein materials used for these systems may fail should their temperature get above a given level. Information provided by this Infrared Temperature Monitoring System to other aircraft data networks would allow measurements to be taken to lower the temperature of the anti-icing system.

FIG. 3 is a functional block diagram of Smart IR Sensor 110 according to some embodiments of the present teachings. Referring to FIG. 3, shows the three main elements of Smart IR Sensor 110, including a sensor housing 302, Transceiver 222, Microprocessor 306, and Calibrated Non-contact Infrared Temperature Sensor (TSM) 348. As stated above, the Transceivers 222 role is to provide the data link and physical layers to TPU 210 for message transmission and reception. Reading the amount of infrared 354 and converting in to a temperature value 350 is the role of the Calibrated Non-contact Infrared Temperature Sensor (TSM) 348. To be able to convert infrared 354 into temperature 350, the TSM sensor 348 must know its own temperature 352 which is another role the TSM 348 provides. Most of the work of the Smart IR Sensor 110 is the role of the Microprocessor 306, it will be managing 600 temperature readings 350, 352 from TSM 348 then comparing them against configuration data 310 stored in Electrically Erasable Programmable Read-Only Memory (EEPROM) 356 which can be updated via the message queue 308. Should the infrared, sensor temperature reading 350, 352 or sensor voltage readings 342 be outside the configured limits in EEPROM 356, the microprocessor 306 will set the appropriate messages 312 and send it to the message queue 308 for transmission to TPU 210.

The messages 312 are given priority levels based on the emergency of the message 312, not only internal to the sensor but on the network as well. Alarms and Warnings 314 indicate some sort of problem and are given the highest priority, as soon as the network finishes its current message, this message will be transmitted as long as there is not another higher priority message. Actual Temperature and Sensor Voltage readings 336 can/do provide useful information as well, and this data is given medium priority. Many communication protocols have state level Communication Status 344, which will be given the lowest priority. Smart IR Sensors 110 will be given priority based on their Sensor Node Address 358—Address 1 has higher priority over Address 2, Address 2 has higher priority over Address 3, and so forth. However, all Alarms and Warnings 314 are highest; for example, Address 2 Alarms and Warning messages 314 will be transmitted first over Address 1's or any others temperature 338, 340 voltage 342 communication messages. This insures that critical messages are handled over all others, no matter how many Smart IR Sensors 110 are on the system.

Many factors come into play with monitoring temperature; different surfaces react differently to its environment. To help counteract these and other system dynamics, three programmable timers 506, 510, 514 are incorporated. Temperature Read Interval 388 sets how often readings are acquired from the TSM 348, the default interval is set at 250 milliseconds. Reasons may occur that this interval may need to be increased and increase the high priority messages response time of Alarms and Warnings 314. Sensor Transmit Interval 384 sets how often Sensor Readings values 336 are transmitted to TPU 210. Communication Status Interval 386 sets how often the lowest priority messages are transmitted; all these come into play when setting up a system on different aircraft. With the ability to configure 310, each Smart IR Sensor 110 contributes in providing a very flexible system.

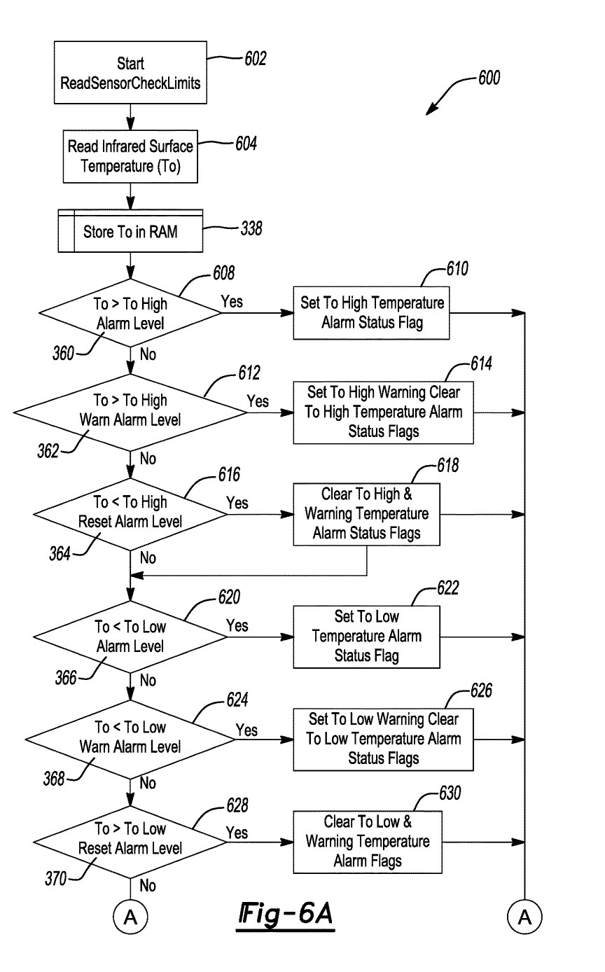

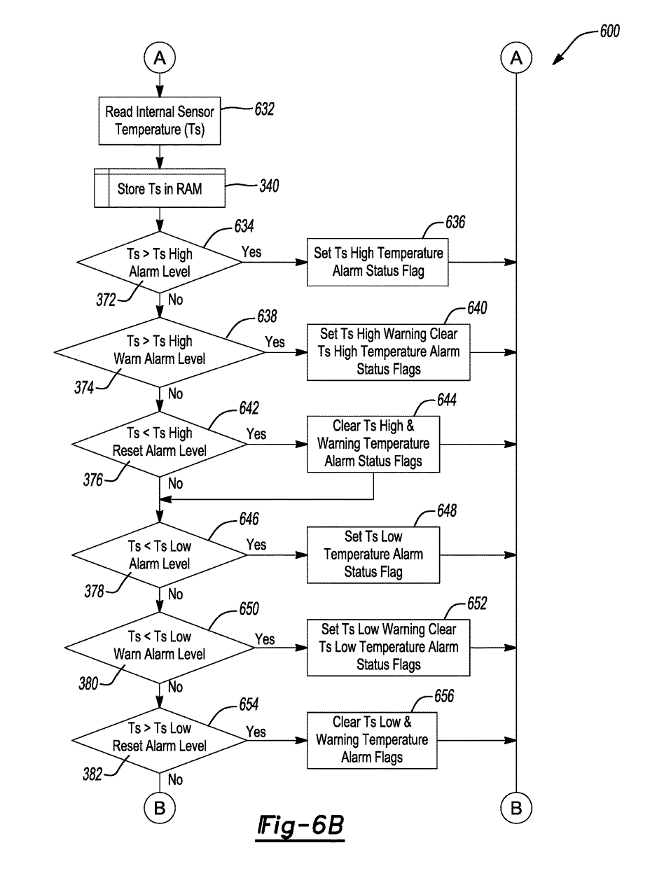

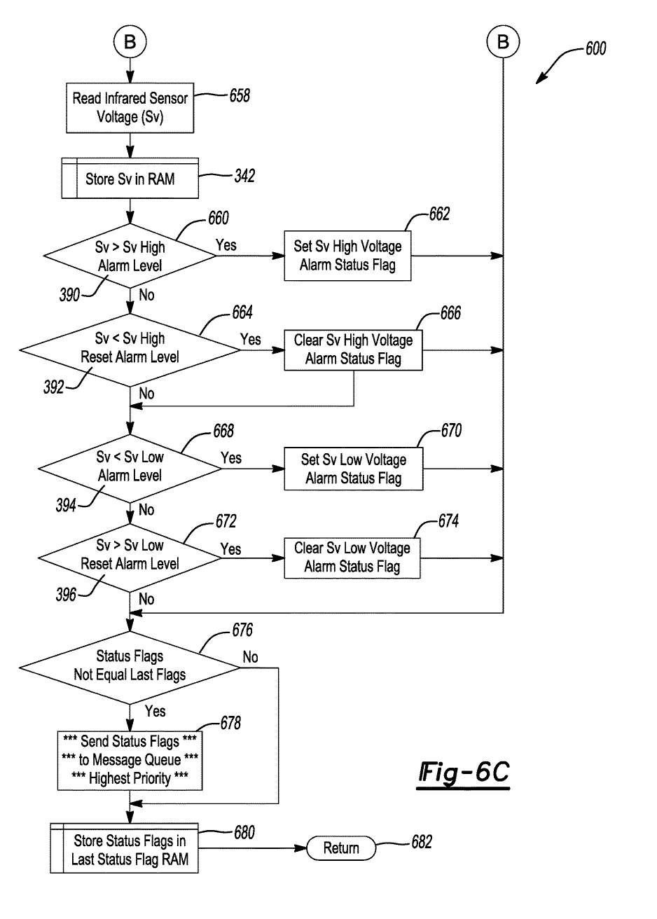

FIG. 4 is a flowchart of the Smart IR Sensor's 110 Main process loop 402, according to some embodiments of the present teachings. Referring to FIG. 4, four major sections 404, 406, 408, 410 of the loop are illustrated. Section 404 calls the communication routines to handle outgoing or incoming messages. These routines may be, but not limited to, any of the now or future approved communication protocols for networks in aircraft. Decision block 406 is the first and highest priority process; if the ReadSensorFlag 508 has been set in the interrupt service routine 502, then it's time to get and check temperature and voltage values from TSM 348. This process 408 calls ReadSensorCheckLimits 602, which determines if any of the alarms/warnings 356 levels have been reached and which messages 314 to send. ReadSensorCheckLim its 602 is detailed in its own flowchart in FIG. 6.

Decision block 410 looks to see if it's time to send sensor values 336. If the SensorTransmitFlag 512 has been set in the interrupt service routine 502, then it's time to send Sensor Reading 336 to the message queue 308 at a medium priority level.

Decision block 414 looks to see if it's time to send communications status 346. If the SendCommFlag 516 has been set in the interrupt service routine 502, then it's time to send communications status 346 to the message queue 308 at the lowest priority level. After the four sections are complete, the loop starts over again.

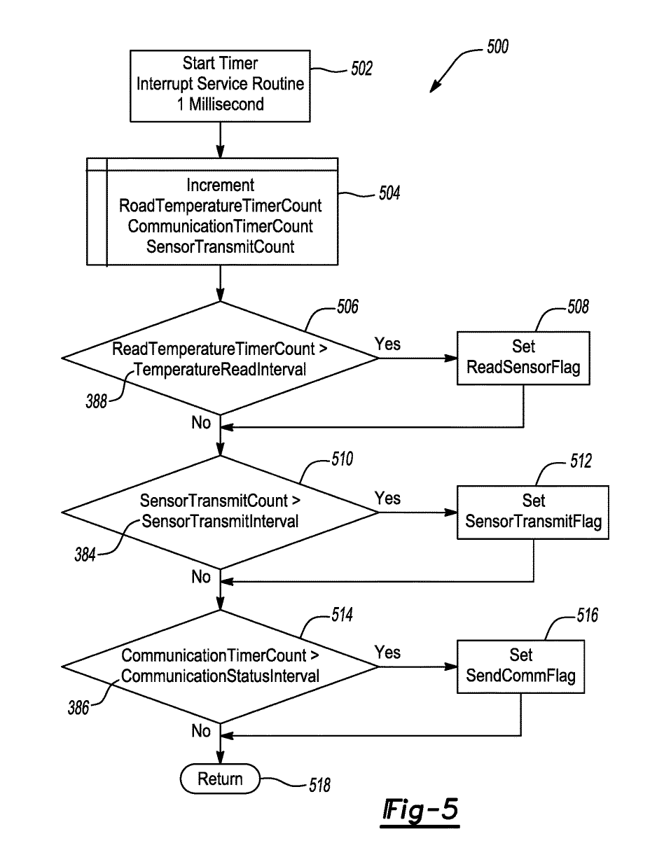

FIG. 5 is a flowchart of the Smart IR Sensor's 110 Interrupt service routine 502, according to some embodiments of the present teachings. Referring to FIG. 5, three major timers that are handled with a 1 millisecond resolution are illustrated. Decision block 506 looks to see if the ReadTemperatureTimerCount 504 is greater than the EEPROM's 356 TemperatureReadlnterval 388; if yes, then the ReadSensorFlag 508 is set so the Main loop 402 will execute ReadSensorCheckLimits 602.

Decision block 510 looks to see if the SensorTransmitCount 504 is greater than the EEPROM's 356 SensorTransmitlnterval 384; if yes, then the SensorTransmitFlag 512 is set so the Main loop 402 will send Sensor Reading 336 to the message queue 308 at a medium priority level.

Decision block 514 looks to see if the CommunicationTimerCount 504 is greater than the EEPROM's 356 CommunicationStatuslnterval 386; if yes, then the SendCommFlag 516 is set so the Main loop 402 will send communications status 346 to the message queue 308 at the lowest priority level.

Interrupt service routines 502 need to execute as quickly as possible and return 518 back to the code it was executing, the use of Flags 508, 512, 514 allow the needed processes to be executed in Main loop 402.

FIG. 6 is a flowchart of the smart infrared temperature sensor Read temperature and decision routine 602, according to some embodiments of the present teachings. Referring to FIG. 6, shows the heart of the Smart IR Sensor's 110 decision processes, each reading Infrared Surface Temperature 604, Internal Sensor Temperature 632, and Infrared Sensor Voltage 658. Each of these readings are compared to their High limit 608, 634, and 660; Warning limit 612, 638; and High Reset limit 616, 642, and 664 to determine if an over temperature/voltage condition exist. Should there be no over temperature/voltage state, it then compares each reading to its Low limi, 620, 646, and 668; Low Warning limit 624 and 650; and Low Reset limit 628, 654, and 672 to determine if an under temperature/voltage condition exists. Each condition Status message flag 610, 614, 622, 626, 636, 640, 648, 652, 662 and 670 is changed to be transmitted at the end of this routine 678. To limit the amount of messages sent on the network, a new message will only be sent if it has changed from the previous message 676. This routine is called from the Main Loop 402 and is executed 408 when new sensor data is available.

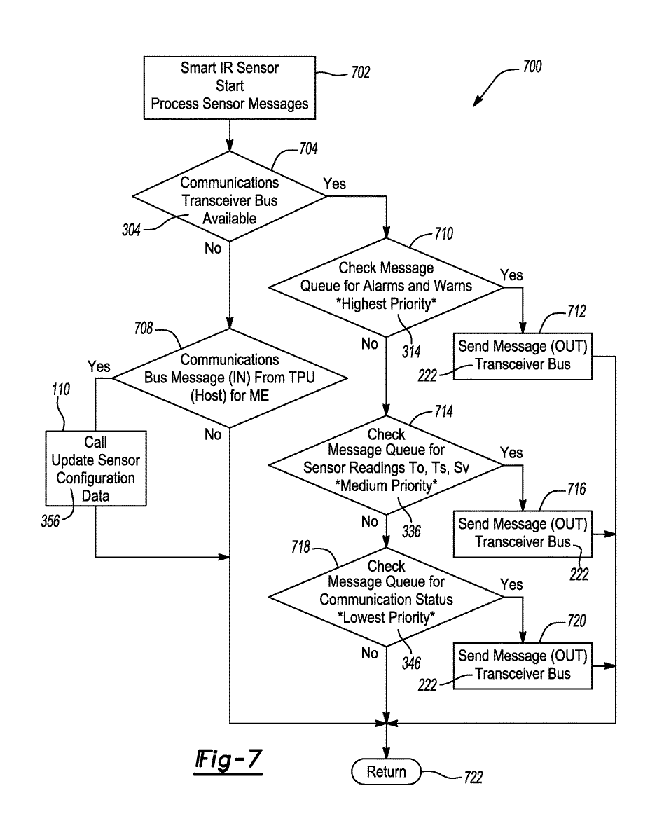

FIG. 7 is a flowchart of the smart infrared temperature sensor Communication decision routine 702, according to some embodiments of the present teachings. Referring to FIG. 7, this routine start off by checking if the Transceiver 222 is available for transmitting 704. If not, it checks to see if the message on the network is a configuration message 708. If the message is for this Smart IR Sensor 110, the received configuration values are sent to update EEPROM 356.

If the Transceiver 222 is available for transmission then the message queue 308 is checked for any high priority Alarms & Warning messages 710, which will be sent out 712 to the transceiver. Should there be no Alarms & Warnings message, it continues to check for any medium priority messages 714, Sensor Readings To, Ts, Sv 336 that may need be go out on the transceiver at this time 716. Communication Status 346 is the lowest priority messages and is checked last 718 and sent if needed 720. This routine is called from Main Loop 402 and is executed 404 each time through the loop.

FIG. 8 is a flowchart of the TPU's 210 Process Host Message routine 802, according to some embodiments of the present teachings. With the majority of the decisions process done at the Smart IR Sensor 110 level, the Temperature Processing Unit 210 main function is to read messages from all the Smart IR Sensors on the networks 218, 220 and provide visual and audio feedback to aircraft crew 204, 208. TPU 210 can also provide a means of Smart IR Sensors configuration 310 as well. This may be within the same GUI program 202 or a separate executable GUI program with limited access for safety concerns.

Referring to FIG. 8, starts off by checking if there are any messages from the networks Smart IR Sensors 110, this is of the highest priority. If not it checks to see if the Configuration data has changed 808 and sends a message 806 to the required Smart IR Sensors 110. This should be a non-flight operation done at a maintenance level.

If messages are available it is first checked to see if it is of the highest priority, Alarms & Warnings 810. These highest priority messages are then sent to update the GUI and Audio alarms 812. If the message is not of a high priority nature, it is then checked to see if meets medium priority standards 814. If it does, GUI 202 is updated for numeric display feedback. Next is the one process check TPU 210 can perform, with the redundant Smart IR Sensors pair 228 pointing at the same field of view 230, Networks A 218 sensors data can be compared to Networks B data 220. A delta different limit would indicate some sort of problem and allow for another possible alarm type to be displayed.

The final step is to check if the incoming message is of the lowest priority level, Communication Status 822. The GUI is updated for these messages as well 824.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An infrared temperature monitoring system for measuring the temperature of areas or subsystems of an aircraft, the system comprising:
a plurality of infrared sensors each configured for non-contact measurement of temperature associated with the areas or subsystems of the aircraft, each of the plurality of infrared sensors having a unique node address, each of the plurality of infrared sensors outputting a sensor signal relative to the unique node address;
a temperature processing unit receiving the sensor signal from each of the plurality of infrared sensors, the temperature processing unit analyzing the sensor signals based at least in part on the unique node address and outputting an interface signal; and
an interface system receiving the interface signal from the temperature processing unit and outputting a control signal.

2. The infrared temperature monitoring system according to claim 1, wherein each of the plurality of infrared sensors comprises:
a sensor housing;
a calibrated non-contact infrared temperature sensor configured to output a temperature signal in response to a measured infrared value of the areas or subsystems of the aircraft;
a processor disposed in the sensor housing, the processor configured to receive the temperature signal from the calibrated non-contact infrared temperature sensor and output the sensor signal; and
a transceiver disposed in the sensor housing, the transceiver configured to communicate the sensor signal to the temperature processing unit.

3. The infrared temperature monitoring system according to claim 2, wherein the processor is further configured to compare the temperature signal to a predetermined limit and selectively output an alarm message to the temperature processing unit, the temperature processing unit configured to receive the alarm message and selectively output the interface signal in response thereto.

4. The infrared temperature monitoring system according to claim 1 wherein the plurality of infrared sensors are each configured for non-contact measurement of temperature of at least one of an anti-icing system, bleed air system, hydraulic fluid system, fuel system, braking system, and wheel system.

5. The infrared temperature monitoring system according to claim 1 wherein the plurality of infrared sensors are configured such that a pair of infrared sensors of the plurality of infrared systems is configured for non-contact measurement of temperature associated with the same area or subsystem of the aircraft to provide redundant measurement of the same area or subsystem of the aircraft.

6. The infrared temperature monitoring system according to claim 5 wherein the temperature processing unit comprises at least two communication buses and wherein each of the pair of infrared sensors is operably coupled to a different one of the at least two communication buses of the temperature processing unit.

7. The infrared temperature monitoring system according to claim 6 wherein the temperature processing unit is configured to compare the sensor signal from a first of the pair of infrared sensors to the sensor signal from a second of the pair of infrared sensors to detect a delta in temperature there between, the temperature processing unit outputting an alarm in the interface signal with the interface system.

8. The infrared temperature monitoring system according to claim 1 wherein the interface system is a graphical user interface system.

9. The infrared temperature monitoring system according to claim 1 wherein the control signal of the interface system is a visual indication of an alarm or warning condition.

10. The infrared temperature monitoring system according to claim 1 wherein the control signal of the interface system is an auditory indication of an alarm or warning condition.

11. The infrared temperature monitoring system according to claim 1 wherein the control signal of the interface system indicates location information based on the unique node address of the associated infrared sensor.

12. The infrared temperature monitoring system according to claim 1 wherein each of the plurality of infrared sensors is configured to individually detect and process individual temperature and alarm conditions, the microprocessor of each of the plurality of infrared sensors assigning a priority level of each of the individual temperature and alarm conditions and selectively outputting the individual temperature and alarm conditions based on its assigned priority level to minimize a processing response time.

13. A method for measuring the temperature of areas or subsystems of an aircraft using an infrared temperature monitoring system, the method comprising:
providing a plurality of infrared sensors each configured for non-contact measurement of temperature associated with the area or subsystem of the aircraft, each of the plurality of infrared sensors having a unique node address;
each of the plurality of infrared sensors measuring a temperature associated with the areas or subsystems and outputting a sensor signal relative to the unique node address;
receiving the sensor signal from each of the plurality of infrared sensors by a temperature processing unit and analyzing the sensor signals based at least in part on the unique node address and outputting an interface signal; and
receiving the interface signal from the temperature processing unit by an interface system and outputting a control signal.

14. The method for measuring the temperature of areas or subsystems of an aircraft using an infrared temperature monitoring system according to claim 13, wherein the step each of the plurality of infrared sensors measuring a temperature associated with the areas or subsystems and outputting a sensor signal relative to the unique node address comprises:
outputting a temperature signal in response to a measured infrared value of the areas or subsystems of the aircraft using a calibrated non-contact infrared temperature sensor;
receiving the temperature signal from the calibrated non-contact infrared temperature sensor by a processor disposed in a sensor housing of each of the plurality of infrared sensors and outputting the sensor signal; and
transmitting the sensor signal to the temperature processing unit via a transceiver disposed in the sensor housing.

15. The method for measuring the temperature of areas or subsystems of an aircraft using an infrared temperature monitoring system according to claim 14, further comprising:
comparing the temperature signal to a predetermined limit and selectively outputting an alarm message to the temperature processing unit by the processor of the infrared sensor.

16. The method for measuring the temperature of areas or subsystems of an aircraft using an infrared temperature monitoring system according to claim 13 wherein the step of each of the plurality of infrared sensors measuring a temperature associated with the areas or subsystems and outputting a sensor signal relative to the unique node address comprises each of the plurality of infrared sensors measuring a temperature associated with at least one of an anti-icing system, bleed air system, hydraulic fluid system, fuel system, braking system, and wheel system.

17. The method for measuring the temperature of areas or subsystems of an aircraft using an infrared temperature monitoring system according to claim 13 wherein the step of each of the plurality of infrared sensors measuring a temperature associated with the areas or subsystems and outputting a sensor signal relative to the unique node address comprises a pair of the plurality of infrared sensors measuring a temperature associated with the same area or subsystem and outputting redundant sensor signals of the same area or subsystem of the aircraft.

18. The method for measuring the temperature of areas or subsystems of an aircraft using an infrared temperature monitoring system according to claim 17 wherein the step of a pair of the plurality of infrared sensors measuring a temperature associated with the same area or subsystem and outputting redundant sensor signals of the same area or subsystem of the aircraft comprises a pair of the plurality of infrared sensors measuring a temperature associated with the same area or subsystem and outputting redundant sensor signals along separate communication buses of the temperature processing unit.

19. The method for measuring the temperature of areas or subsystems of an aircraft using an infrared temperature monitoring system according to claim 18, further comprising:
comparing the sensor signal from a first of the pair of infrared sensors to the sensor signal from a second of the pair of infrared sensors to detect a delta in temperature there between, the temperature processing unit outputting an alarm in the interface signal with the interface system.

20. The method for measuring the temperature of areas or subsystems of an aircraft using an infrared temperature monitoring system according to claim 13, further comprising:
assigning a priority level of each of the individual temperature and alarm conditions and selectively outputting the individual temperature and alarm conditions based on its assigned priority level.
